(19) United States
(12) Patent Application Publication
(10) Pub. No.: US 2023/0075249 A1
(43) Pub. Date: Mar. 9, 2023

(54) PORTABLY FOLDABLE CONDIMENT PACKET CADDY

(71) Applicants: Scott William Clifton, Smyrna, GA (US); Conrad Marshall Curran, Alpharetta, GA (US)

(72) Inventors: Scott William Clifton, Smyrna, GA (US); Conrad Marshall Curran, Alpharetta, GA (US)

(21) Appl. No.: 17/930,241

(22) Filed: Sep. 7, 2022

Related U.S. Application Data
(60) Provisional application No. 63/241,354, filed on Sep. 7, 2021.

(51) Int. Cl. A47B 31/06; B60R 7/08

(52) U.S. Cl. CPC A47B 31/06; B60R 7/08

(57) ABSTRACT

A portably foldable condiment packet caddy is provided. The condiment packet caddy is foldable from a planar blank form to a triangular prism retainer having openings for slidably receiving and retainer condiment packets. The foldable retainer provides a foldable latch that ends in a hook for engaging an upper portion of a vehicle door so that the rear wall of the retainer coactively supports the engaged hook by way of the foldable latch having a series of spaced apart joints for selectively defining a curvature to facilitate the coactive support between the hook, the rear wall of the retainer and the vehicle door.

### CROSS-REFERENCE TO RELATED APPLICATION

This application claims the benefit of priority of U.S. provisional application number 63/241,354, filed 07-SEP-2021, the contents of which are herein incorporated by reference.

### BACKGROUND OF THE INVENTION

The present invention relates to vehicular food trays and, more particularly, a vehicular food caddy having a foldable design to hang on the vehicle’s door window to retain condiment packets.

There is an estimated 200,000+ drive-thru fast-food operations across the U.S. in 2020. Americans visit drive-thru fast-food lanes about 6 billion times each year according to some statistics.

It is difficult, however, to balance eating fast food that is eaten with sauce contained in condiment packets when in a vehicle, generally, and especially when in the vehicle is on the go. The condiment packets generally hold only one ounce of condiment, and typically the condiment is meant for dipping a portion of a large food product into the condiment packet. Doing such dipping when sitting in the confines of a vehicle without a tray or shelf can be uncomfortable and awkward while the vehicle is stopped, and rather challenging when the car is in motion because the user must use both hands, unless they are precariously balancing the condiment packet on their lap.

Current condiment packet caddy devices attach to the air vent within the vehicle which spreads the odor throughout the vehicle, as well as it heats up the condiment packet affecting how it tastes to and how it is appreciated by the consumer.

As can be seen, there is a need for a vehicular food caddy having foldable design to hang on the vehicle’s door window to hold condiment packets, thereby preventing the spread of odor throughout the vehicle. The present invention also provides easier access for the consumer through enabling insertion by way of a latch tab, into the vehicle’s door window allowing for holding the condiment packets in a stationary position on the side of the door.

### SUMMARY OF THE INVENTION

In one aspect of the present invention, a portably foldable retaining caddy includes a foldable retainer; and a foldable latch comprising a series of spaced apart joints for selectively defining a curvature of the foldable latch as it extends from the foldable retainer to a hook dimensioned to engage a slot.

In another aspect of the present invention, the portably foldable retaining caddy further includes: a plurality of latch segments interconnecting adjacent joints of the series of spaced apart joints; an upper retainer portion having a plurality of openings, wherein the upper retainer portion is pivotably connected to the foldable latch by way of a rear joint along a longitudinal edge of the upper retainer portion; two gusset retainer portions, one foldable attached to each longitudinal end of the upper retainer portion by way of respective side fold lines; a tabbed rear retainer portion rearwardly extending, along a from one of the two gusset retainer portions; and a slotted rear retainer portion rearwardly extending from another of the two gusset retainer portions, wherein each rear retainer portion is foldable connected to its gusset portion by a rear fold line, respectively, wherein the retainer portions are movable between a flat condition and a closed position by folding along said fold lines, wherein in the closed position the foldable retainer defines a triangular prism, and wherein in the rear retainer portions in the closed position form a rear wall of the foldable retainer, wherein the rear wall is one side of the triangular prism.

In yet another aspect of the present invention, the method of retaining condiment packets along an interior of a vehicle, the method includes providing the above-mentioned portably foldable retaining; inserting the hook into an upper portion of a door of the vehicle; and bending each of the series of spaced apart joints and the rear joint so that the rear wall and the hook have a substantially parallel orientation relative to each other so that the rear wall engages an interior-facing panel of said door.

These and other features, aspects and advantages of the present invention will become better understood with reference to the following drawings, description and claims.

### BRIEF DESCRIPTION OF THE DRAWINGS

FIG. 1 is a top perspective view of an exemplary embodiment of the present invention, shown in use.

FIG. 2 is a detailed exploded top perspective view of an exemplary embodiment of the present invention, shown in use.

FIG. 3 is a top perspective view of an exemplary embodiment of the present invention.

FIG. 4 is a plan view of an exemplary embodiment of a blank of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a portably foldable condiment packet caddy is provided. The condiment packet caddy is foldable from a planar blank form to a triangular prism retainer having openings for slidably receiving and retainer condiment packets. The foldable retainer provides a foldable latch that ends in a hook for engaging an upper portion of a vehicle door so that the rear wall of the retainer coactively supports the engaged hook by way of the foldable latch having a series of spaced apart joints for selectively defining a curvature to facilitate the coactive support between the hook, the rear wall of the retainer and the vehicle door.

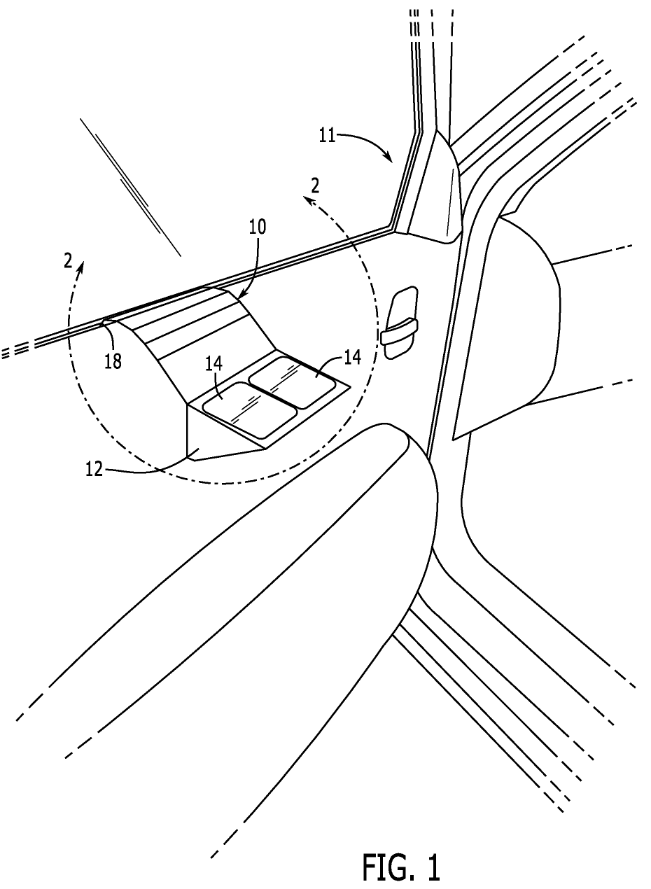

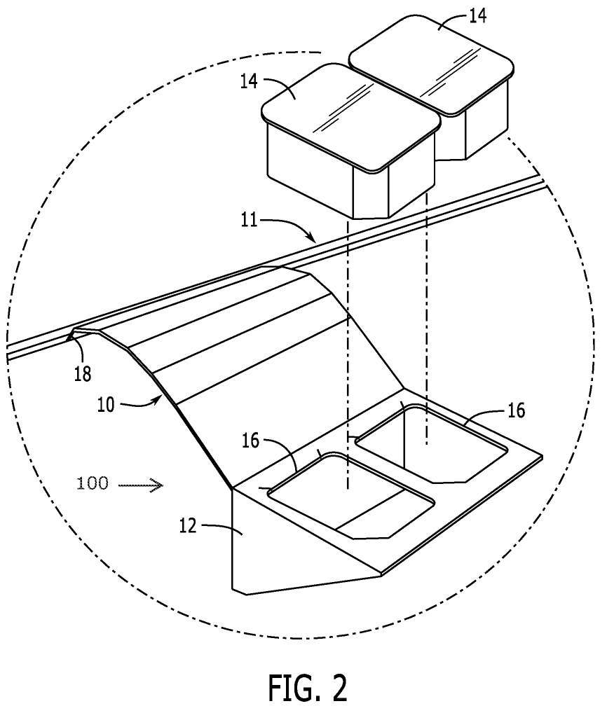

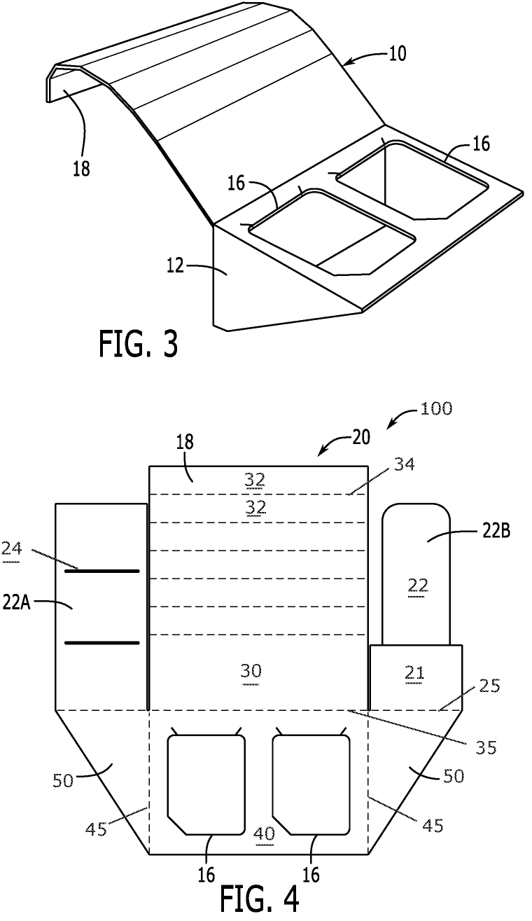

Referring now to FIGS. 1 through 4, the present invention may include a portably foldable condiment packet caddy 100 having a foldable retainer 12 operatively associated with a foldable latch 10 so that the portably foldable condiment packet caddy 100 can be secured to and supported by a door of a vehicle 11.

The portably foldable condiment packet caddy 100 may be made from a blank 20 of any material that is sufficiently resilient, durable, flexible, and stiff enough for the present use environment, such as, but not limited to, wood-based materials, including particle board, a plastic-wood composite material, a laminated material, metal, various plasticized materials, fiberglass, composites, polymers, copolymers, carbon fiber, or plexiglass.

The foldable retainer 12 may define a triangular prism when formed from a portion of the blank 20. In planar blank 20 form, the retainer 12 may be defined by a first latch portion 30 pivotably coupled to a longitudinal edge of an upper retainer portion 40 by way of a rear fold line 35, wherein the retainer portion 12 is further defined by a gusset portion 50 pivotably coupled to each opposing side of the upward portion 40 by way of a side fold line 45, respectively.

The upper retainer portion 40 defines a plurality of openings 16 dimensioned and adapted to slidably receive a condiment packet 14. A condiment packet 14 may have a generally cuboid with tapered sidewall, or a quadrilateral frustum form, to facilitate slidably being received by an opening 16 until the periphery of the opening 16 engages a portion of the sidewall or the underside of an overhang flange standard in many condiment packets 14. Though it should also be understood that differently shaped condiment packets 14, such as cylindrical and the like, and thus differently shaped openings 16 are contemplated by the present invention.

Extending rearward (in the same direction as the first latch portion 30 relative to the upper retainer portion 40) is a slotted rear retainer portion 22A from one gusset portion 50 and a tabbed rear retainer portion 22B from the other gusset portion 50 so that the rear retainer portions 22A and 22B are spaced apart (in planar blank form) by at least a width of the foldable latch 12. Each rear retainer portion 22A and 22B is foldable connected to its gusset portion 50 by way of a fold line 25. The tabbed rear retainer portion 22B can include a tabbed main portion 21 and a tab 22 to selectively engage one or a plurality of slots 24 along the slotted rear retainer portion 22A when in the foldable retainer 12 is folded to the closed position defining the completed foldable retainer 12, wherein the rear retainer portions 22A and 22B form the rear wall of the foldable retainer 12. The above-mentioned portions 40, 50, 22A and 22B are foldable from the planar blank 20 form to the triangular prism foldable retainer 12 and back.

As mentioned above, the first latch portion 30 is pivotably connected to the retainer 12 by way of the rear fold line 35. The foldable latch 10 includes a linear series of planar latch segment 32 each pivotably connected to each other, the first latch portion 30, or a distal hook 18 by a fold line/living hinge/joint 34. These joints 34 enable each latch segment 32 to bend relative to its adjacent latch segment 32 (or the first latch portion 30 or the distal hook 18), thereby allowing the first latch portion 30 and the distal hook 18 to form a parallel orientation relative to each other as the intervening latch segments 32 defining an approximately 180-degree curvature, in some but not all embodiments.

The planar distal hook 18, the foldable latch 10, and the foldable retainer 14 work together to provide structural support for the portably foldable condiment packet caddy 100. Specifically, the hook 18 may be inserted into the slot of the vehicle door 11 window while the rear wall of the foldable retainer 12 rests against a surface of the vehicle door 11 along the interior of the vehicle, through foldable latch 10 being adjustably bent along each latch joint 34 to define a curved foldable latch 10 between the hook 18 and the retainer 12. Accordingly, it may be seen that the rear wall of the retainer 12 may be engaged with the outer interior panel of the door 11 for coaction with the downturned distal hook 18 to support the retainer 12 from the inside of the vehicle door 11. The bendable nature of the series of latch joint 34 makes the present invention usable on various differently sized, shaped, and dimensioned vehicle doors 11 and thus different vehicle types.

A method of making the present invention may include the following. Once a blank 20 is procured, it must be cut out to the desired dimensions. This can be done using proper cutting equipment. The blank 20 is then perforated, modified, and/or indented in targets areas (fold lines 35 and 45 and joints 34) to allow for ease of folding and for adjusting the curve of the latch 10. Guidelines could be placed on the blank 20 itself that match the dimensions of all interior vehicle windows.

A method of using the present invention may include the following. The portably foldable condiment packet caddy 100 disclosed above may be provided. After folding the blank 20 so that the foldable retainer 12 is in the operable closed position, the consumer would fold the latch 10 along its joints 34 and attach the latch 10 to the vehicle door 11 by inserting the distal latch hook 18 therein. The condiment packets 14 would be inserted in the openings 16 of the retainer 12. It is understood that the retainer 12 could be utilized to hold other items on the side of car doors besides condiment packets.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A portably foldable retaining caddy comprising:
a foldable retainer; and
a foldable latch comprising a series of spaced apart joints for selectively defining a curvature of the foldable latch as it extends from the foldable retainer to a hook dimensioned to engage a slot.

2. The portably foldable retaining caddy of claim 1, further comprising:
a plurality of latch segments interconnecting adjacent joints of the series of spaced apart joints.

3. The portably foldable retaining caddy of claim 2, wherein the foldable retainer comprises:
an upper retainer portion having a plurality of openings, wherein the upper retainer portion is pivotably connected to the foldable latch by way of a rear joint along a longitudinal edge of the upper retainer portion.

4. The portably foldable retaining caddy of claim 3, wherein the foldable retainer further comprises:
two gusset retainer portions, one foldable attached to each longitudinal end of the upper retainer portion by way of respective side fold lines;
a tabbed rear retainer portion rearwardly extending, along a from one of the two gusset retainer portions; and
a slotted rear retainer portion rearwardly extending from another of the two gusset retainer portions.

5. The portably foldable retaining caddy of claim 4, wherein each rear retainer portion is foldable connected to its gusset portion by a rear fold line, respectively.

6. The portably foldable retaining caddy of claim 5, wherein the retainer portions are movable between a flat condition and a closed position by folding along said fold lines.

7. The portably foldable retaining caddy of claim 6, wherein in the closed position the foldable retainer defines a triangular prism.

8. The portably foldable retaining caddy of claim 7, wherein in the rear retainer portions in the closed position form a rear wall of the foldable retainer, wherein the rear wall is one side of the triangular prism.

9. A method of retaining condiment packets along an interior of a vehicle, the method comprising:
providing the portably foldable retaining caddy of claim 8;
inserting the hook into an upper portion of a door of the vehicle; and
bending each of the series of spaced apart joints and the rear joint so that the rear wall and the hook have a substantially parallel orientation relative to each other so that the rear wall engages an interior-facing panel of said door.
